(19) United States
(12) Patent Application Publication
(10) Pub. No.: US 2009/0228791 A1
(43) Pub. Date: Sep. 10, 2009

(54) FULL-BROWSING DISPLAY METHOD OF TOUCH SCREEN APPARATUS USING TACTILE SENSORS, AND RECORDING MEDIUM THEREOF

(75) Inventors: Jong Ho KIM, Daejeon (KR); Dae Im Kang, Daejeon (KR); Yon Kyu Park, Daejeon (KR); Min Seok Kim, Daejeon (KR); Jae Hyuk Choi, Daejeon (KR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Korea Research Institute of Standards and Science, Daejeon (KR)

(21) Appl. No.: 12/191,087

(22) Filed: Aug. 13, 2008

(30) Foreign Application Priority Data
Mar. 10, 2008 (KR) 10-2008-22136

(51) Int. Cl. G06F 3/01

(52) U.S. Cl. 715/702

(57) ABSTRACT

The present invention relates to a full-browsing display method of a touch screen apparatus using tactile sensors, and more specifically, to a full-browsing display method, in which after setting a reference force Fₛ, if a user sets any one of an enlargement mode, a reduction mode, and a screen movement mode for a web-site screen displayed on the touch screen apparatus and applies an action force Fᵢₙ at a position of the web-site screen where a change is desired, enlargement or reduction of the screen is determined depending on the strength of the action force, and movement of the screen or a click is determined by comparing the action force with the reference force Fₛ.

### BACKGROUND OF THE INVENTION

1. Field of the Invention

The present invention relates to a full-browsing display method of a touch screen apparatus using tactile sensors, and more specifically, to a full-browsing display method, in which after setting a reference force Fₛ, if a user sets any one of an enlargement mode, a reduction mode, and a screen movement mode for a web-site screen displayed on the touch screen apparatus and applies an action force Fᵢₙ at a position of the web-site screen where a change is desired, enlargement or reduction of the screen is determined depending on the strength of the action force, and movement of the screen or a click is determined by comparing the action force with the reference force Fₛ.

2. Background of the Related Art

As ultra high-speed mobile communication techniques, such as HSDPA, mobile Internet WiBro, and the like, which are 3.5 generation mobile communications, are commercialized recently, an interest in full-browsing is growing. Particularly, although a web-site for a personal computer (PC) may be displayed on a cellular phone or the like, it is not easy to implement Internet screens for a PC as they are on a narrow screen of a cellular phone or the like. Therefore, a user scrolls the screen up and down or left and right to read a web page or views the entire screen by adjusting the screen with a zoom-in zoom-out function.

When a web page is read by moving scroll bars up and down or left and right in the prior art, it is inconvenient to handle the scroll bars placed at the left and right sides, and there is a problem in that the screen area is further narrowed since the space occupied by the scroll bars formed on the bottom and right sides of the screen is large.

Furthermore, in the case where the screen is adjusted by zooming-in and zooming-out the screen in the prior art, if it is set to enlarge a corresponding web page screen, for example, double each time when the touch screen mounted on a cellular phone or the like is handled with a pointing object (e.g., a finger, a stylus tip, or the like), and if a corresponding web page screen is desired to be enlarged eight times as large as before, there is a problem in that efficiency in handling the touch screen is lowered since the touch screen needs to be handled three times. Then, such a problem in efficiency makes it inconvenient to use full-browsing at a portable terminal (e.g., cellular phone, personal data assistant (PDA), or the like) which acts as a reason why using the full-browsing is avoided.

### SUMMARY OF THE INVENTION

The present invention has been made in an effort to solve the above problems, and it is an object of the present invention to provide a full-browsing display method of a touch screen apparatus for inputting a position or operation command by a user using a pointing object (e.g., a finger, stylus tip, or the like), in which after setting a reference force, if a user sets any one of an enlargement mode, a reduction mode, and a screen movement mode for a web-site screen displayed on the touch screen apparatus and applies an action force at a position of the web-site screen where a change is desired using the pointing object, enlargement or reduction of the screen is determined depending on the strength of the action force, and movement of the screen or a click is determined by comparing the action force with the reference force. The apparatus comprises a touch screen that is a medium to which an action force of the pointing object is applied and a reaction force according thereto is transferred; and a tactile sensor arranged along an edge of a bottom surface of the touch screen, for detecting the action force and generating a certain signal.

To accomplish the above object, in one aspect, the present invention provides a full-browsing display method of a touch screen apparatus using tactile sensors, the apparatus comprising a touch screen that is a medium for allowing a user to input a position or operation command thereto using a pointing object, being applied with an action force of the pointing object, and recognizing the applied position information; and a plurality of tactile sensors arranged along an edge of a bottom surface of the touch screen, for detecting the action force and generating a certain signal. The full-browsing display method comprises: a mode setting step for setting, based on an input of the user, any one of an enlargement mode, a reduction mode, and a screen movement mode of a screen displayed on the touch screen apparatus; a magnitude detecting step for recognizing position information from the touch screen and detecting the magnitude of an action force from the tactile sensor when the action force is inputted; and a screen determining step for determining and displaying an enlargement or reduction ratio of the screen, movement of the screen, or generation of a click event based on the recognized position information, the magnitude of the detected action force, and the mode that is set in the mode setting step.

When the enlargement or reduction mode of the screen is selected in the mode setting step, the enlargement or reduction ratio of the screen may be determined in proportion to an absolute value of the action force in the screen determining step.

In addition, the screen determining step may further comprise the step of moving a screen of a point where the action force is applied to a center of the touch screen based on the position information.

In addition, the method preferably further comprises a reference force setting step of allowing the user to set the reference force before performing the mode setting step.

Then, the method further preferably comprises a connection step, between the reference force setting step and the mode setting step, of connecting to a web site by inputting an address of the web site in an Internet address window of the touch screen apparatus or specifying the web site through favorites.

In addition, the screen determining step may most preferably comprise the steps of comparing the magnitude of the action force with magnitude of the set reference force; and determining the enlargement or reduction ratio of the screen, movement of the screen, or generation of the click event based on a result of the comparison.

Then, the comparison step may compare the magnitude of the action force with the magnitude of the reference force by subtracting or dividing the magnitude of the action force from or by the magnitude of the reference force.

In addition, when the screen movement mode is selected in the mode setting step, the screen determining step may preferably comprise the steps of: displaying the screen of the touch screen apparatus moving along a trajectory of the applied action force, when the magnitude of the action force is smaller than the magnitude of the reference force, and displaying the screen moving to a hyperlinked specific web site according to generation of the click event at a point where the action force is applied, when the magnitude of the action force is greater than the magnitude of the reference force.

Then, if the magnitude of the action force is greater than the magnitude of the reference force, the method most preferably further comprises the step of outputting a certain effect sound or vibration to give a feeling of a click when the screen moves to the hyperlinked web site.

In addition, the magnitude detecting step S35 for detecting the magnitude of the action force may detect a maximum value or an average value of output signals outputted by the plurality of tactile sensors as the magnitude of the action force.

In another aspect, the present invention provides a recording medium that is readable by a computing system included in a touch screen apparatus comprising a touch screen 210 that is a medium for allowing a user to input a position or operation command thereto using a pointing object, being applied with an action force of the pointing object, and recognizing the applied position information; and a plurality of tactile sensors placed along an edge of a bottom surface of the touch screen, for detecting the action force and generating a certain signal. The recording medium has a program recorded thereon for executing: a reference force setting step of allowing the user to set the reference force; a mode setting step of setting, based on an input of the user, any one of an enlargement mode, a reduction mode, and a screen movement mode of a screen displayed on the touch screen apparatus; a magnitude detecting step of recognizing position information from the touch screen and detecting the magnitude of the action force from the tactile sensor when the action force is inputted; and a screen determining step of determining and displaying an enlargement or reduction ratio of the screen, movement of the screen, or generation of a click event based on the recognized position information, the magnitude of the detected action force, and the set mode.

In the full-browsing display method of a touch screen apparatus using tactile sensors according to the present invention, enlargement, reduction, and movement of a screen is determined by applying an action force only once to a point desired to be changed on a web page screen displayed on the touch screen apparatus by a user, and thus the screen of a cellular phone or the like can be further efficiently used by removing scroll bars conventionally used to move the screen

Furthermore, since a screen is changed depending on the strength of an action force, a desired screen can be changed by applying an action force only once using a pointing object without handling the screen a plurality of times, and thus efficiency and convenience of handling the touch screen can be achieved.

### BRIEF DESCRIPTION OF THE DRAWINGS

The above and other objects, features and advantages of the present invention will be apparent from the following detailed description of the preferred embodiments of the invention in conjunction with the accompanying drawings.

FIG. 1 shows a basic configuration of a touch screen apparatus;

FIG. 2 is a front view showing a touch screen apparatus using tactile sensors, mounted on a cellular phone;

FIG. 3 is a side cross-sectional view showing a tactile sensor;

FIG. 4 is a block diagram showing an installation flow of a touch screen apparatus using tactile sensors;

FIGS. 5a and 5b are views showing arrangement of control means for determining enlargement, reduction, and movement of a screen, when a touch screen apparatus using tactile sensors is mounted on a cellular phone;

FIG. 6 is a flow chart illustrating a full-browsing display method of a touch screen apparatus using tactile sensors according to the present invention;

FIG. 7 is a view showing enlargement of a screen displayed on a touch screen apparatus;

FIG. 8a is a view showing a plurality of active windows floated on a touch screen; and

FIG. 8b is a view showing an active window and an inactive window displayed on a screen of a touch screen.

### DETAILED DESCRIPTION OF THE PREFERRED EMBODIMENT

The preferred embodiments of the invention will be hereafter described in detail with reference to the accompanying drawings.

<Configuration of Touch Screen Apparatus for Full-Browsing>

A full-browsing display method of the present invention is implemented in a touch screen apparatus using tactile sensors, and first, the configuration and basic operation of the touch screen apparatus using tactile sensors will be described.

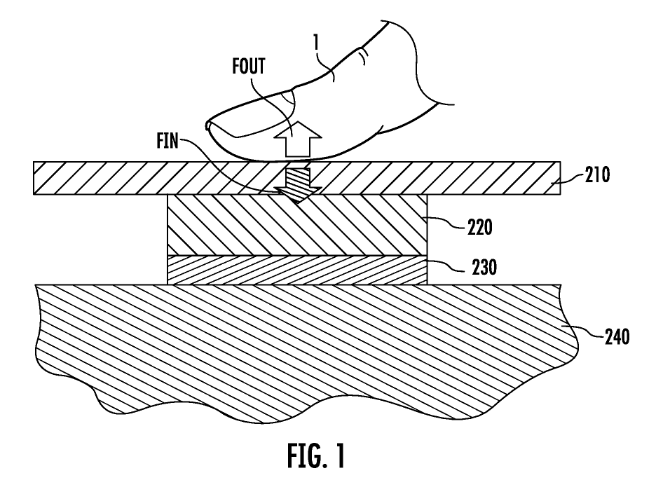

FIG. 1 is a view showing the basic configuration of a touch screen apparatus. The touch screen apparatus using tactile sensors basically comprises a touch screen 210 that is a medium for being applied with an action force Fᵢₙ from a pointing object 1 and recognizing position information of the action force, and a plurality of tactile sensors 230 placed below the touch screen, for detecting the action force Fᵢₙ and outputting a certain signal.

Preferably, the touch screen apparatus further comprises an actuator 220 for outputting vibration to give a user a feeling of a click when a screen is hyperlinked to another web site by handling the touch screen apparatus, and a control unit 440 for outputting a certain control signal for driving the actuator 220 based on the signal of the tactile sensor 230 and position information of the action force applied on the touch screen.

FIG. 1 shows the actuator 220 mounted on the top of the tactile sensor 230. However, positions of the actuator 220 and the tactile sensor 230 may be changed with each other. In addition, specific wiring of the actuator 220 and the tactile sensor 230 is an easy work within the scope of those skilled in the art, and thus detailed descriptions thereof will be omitted here.

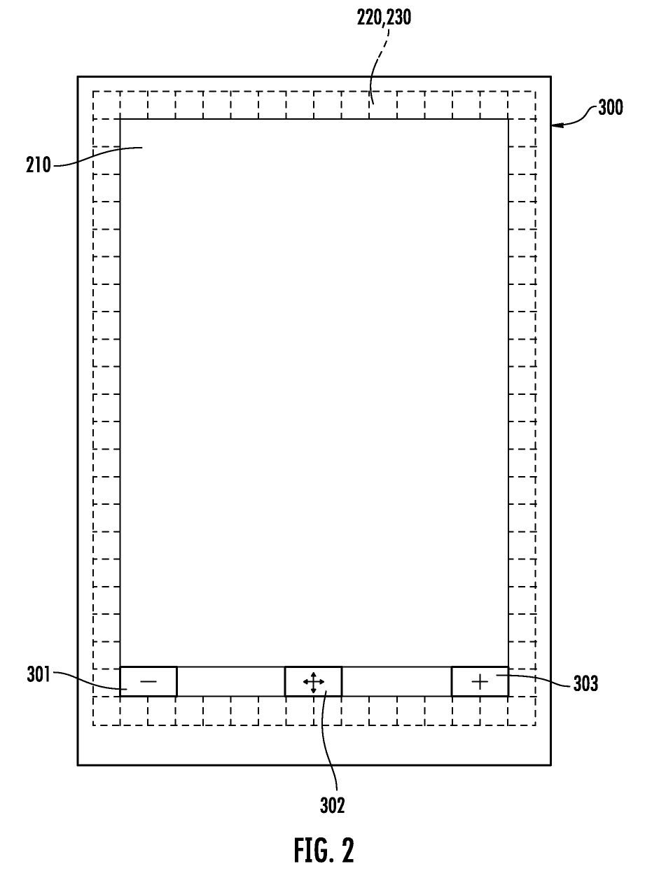

The actuator 220 and the tactile sensor 230 are formed as a single unit body, and a plurality of unit bodies are preferably arranged along the edge of the bottom surface of the touch screen as shown in FIG. 2. This is not to hinder the display function of the touch screen 210. In addition, since a plurality of tactile sensors 230 is arranged along the edge of the bottom surface of the touch screen 210, respective action forces Fᵢₙ may be detected even when the action forces Fᵢₙ are applied at a plurality of points in a method of multi-touching or dragging the pointing object 1 or 1′.

The touch screen 210 is an input medium for receiving a position of the cursor or the like and an operation command on the display based on the position of the pointing object 1 contacted with the touch screen. The touch screen 210 may be a touch screen used in an LCD, OLED, PDP, electronic ink display apparatus, or the like, or a flexible touch screen. Recognition of position information of the pointing object 1 applied to the touch screen and features of the LCD, OLED, PDP, and electronic ink display apparatus are well-known within the scope of those skilled in the art, and thus detailed descriptions thereof will be omitted here.

The tactile sensors 230 are placed below the touch screen 210 and generates and outputs a signal based on an action force Fᵢₙ of the pointing object 1 applied on the touch screen 210. The signal generated by the tactile sensor 230 has a value proportional to the strength of the action force Fᵢₙ applied by the user.

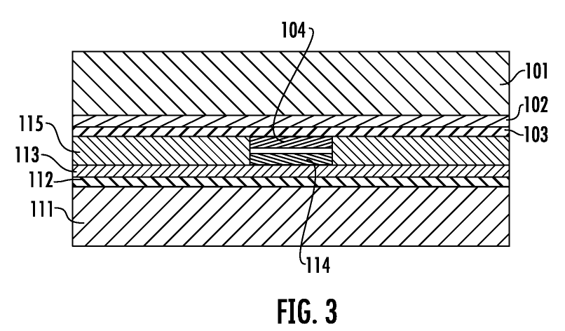

FIG. 3 shows the configuration of a tactile sensor 230, and the tactile sensor comprises an upper plate manufactured by forming a coating layer 102 and a metal layer 103 on a polymer film 101 of a certain thickness in order and forming a resistive element 104 on the metal layer 103, and a lower plate manufactured by forming a coating layer 112 and a metal layer 113 on a polymer film 111 of a certain thickness in order and forming a resistive element 114 on the metal layer 113. The upper plate and lower plate are bonded together including a spacer 115 interposed between them so that the resistive element 104 of the upper plate and the resistive element 114 of the lower plate are faced each other.

The control unit 440 generates a control signal based on a signal corresponding to the action force Fᵢₙ detected by the tactile sensor 230 and the position information of the action force applied on the touch screen and transmits the control signal to the actuator 220. The control unit 440 is an ultra micro type, and it is preferable to use a microcomputer (MICOM), central processing unit (CPU), or special-purpose chipset that can be easily embedded in a computer, portable electronic device (a PDA terminal, or cellular phone), or the like.

Since the control unit 440 should generate a control signal for driving the actuator 220 as much as to sufficiently deliver a reaction force Fₒᵤₜ through the touch screen, it is preferable that information needed for generating such a control signal is previously embedded in the control unit 440 as a function or a lookup table.

The actuators 220 are placed along the edge of the bottom surface of the touch screen 210 and driven (rotational, linear, or translational motion) to output certain vibration to the user. That is, in the present invention, when the screen is hyperlinked to another web site by handling the pointing object 1 on the touch screen, certain vibration (e.g., a reaction force Fₒᵤₜ or the like reflecting attributes of the action force Fᵢₙ and proportional to the attributes) is outputted in order to give the user a feeling of a click. At this point, if needed, the touch screen apparatus may be configured to output a sound (e.g., a sound of “click”) through a speaker (not shown). A piezoelectric actuator, voice coil actuator, polymer actuator, or the like can be used as the actuator 220. The features of the actuator are apparent within the scope of those skilled in the art, and thus detailed descriptions thereof will be omitted.

<Method of Driving Touch Screen Apparatus for Full-Browsing>

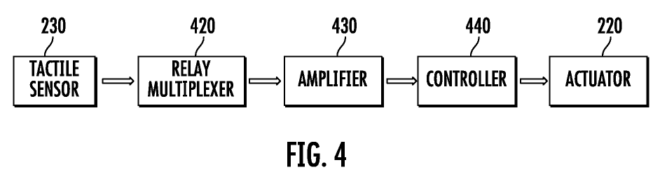

Hereinafter, a fundamental method for driving the touch screen apparatus will be briefly described with reference to the installation flow of the touch screen apparatus shown in FIG. 4. As shown in FIG. 4, when a user applies an action force Fᵢₙ, a certain signal is generated from the tactile sensor 230 where a signal line is formed. At this time, the certain signal generated from the tactile sensor 230 is shown as a value proportional to the strength of the action force Fᵢₙ.

Before being applied to the control unit 440, the signal generated from the tactile sensor 230 is preferably processed through a relay multiplexer 420 for sequentially detecting the signals indicative of the action force generated from the tactile sensor 230 and an amplifier 430 for amplifying the signal of the multiplexer 420 to a certain level.

Here, various types of amplifiers such as an analog amplifier, a digital amplifier, a voltage amplifier and the like may be used as the amplifier 430. In addition, the touch screen apparatus preferably further includes a noise cancellation unit (not shown: e.g., a band-pass filter or a low-pass filter) for removing noises included in the signal generated from the tactile sensor 230. By removing the noises, efficiency can be enhanced when the reaction force is implemented. Since the digital amplifier consumes less power and is small in size, it can be easily embedded in a computer, a portable electronic product, or the like. Since the digital amplifier can be manufactured as one ASIC (application specific integrated circuit), it is advantageous in that it can be manufactured on a large scale. When the digital amplifier is used, the touch screen apparatus preferably further includes an analog-to-digital converter (ADC (not shown) or a digital-to-analog converter (DAC) (not shown) for performing conversion of between analog and digital signals.

The control signal generated based on the attribute information (e.g., position, strength, and the like) of the action force Fᵢₙ and processed by the control unit 440 is applied to the actuator 220, and the actuator performs linear, translational, or rotational motions or the like to deliver certain vibration (e.g., a reaction force Fₒᵤₜ reflecting attributes of the action force Fᵢₙ and proportional to the attributes) so that the user may recognize the vibration.

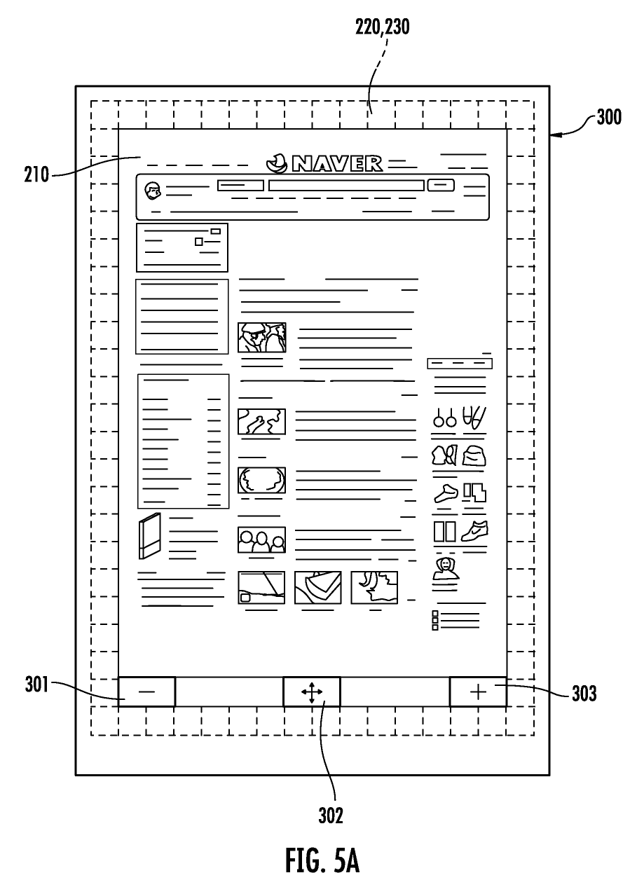

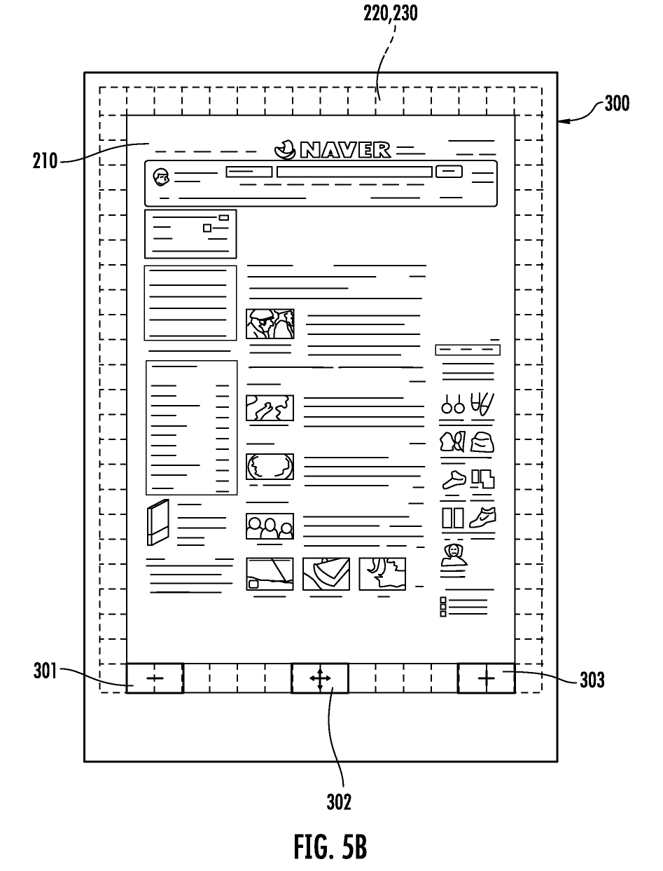

FIGS. 5a and 5b show a touch screen apparatus using tactile sensors that is mounted on a cellular phone, in which screen control means for determining enlargement 303, reduction 301, and screen movement 302 are placed as screen control means of a web site needed to display full-browsing. FIG. 5a shows a first embodiment, in which the screen control means for determining enlargement 303, reduction 301, and screen movement 302 are displayed as buttons on the touch screen to be shown to the user, and FIG. 5b shows a second embodiment, in which the screen control means for determining enlargement 303, reduction 301, and screen movement 302 are provided as mechanical buttons outside of the touch screen.

<Full-Browsing Display Method>

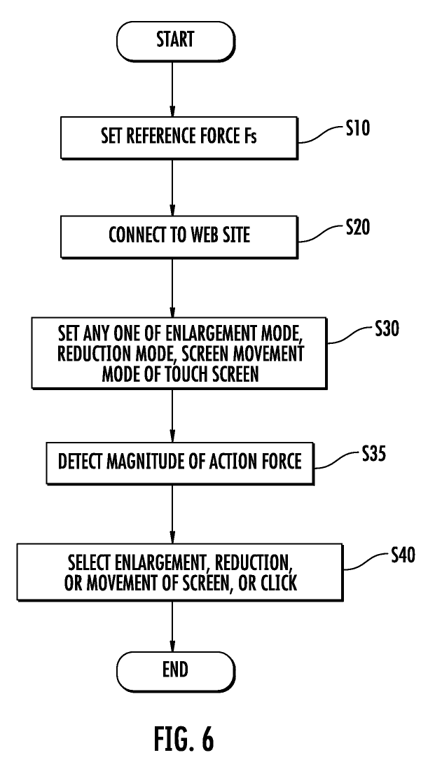

As shown in FIG. 6, a full-browsing display method of the touch screen apparatus using tactile sensors according to an embodiment of the present invention comprises a mode setting step S30 for setting, based on an input of a user, any one of an enlargement mode, a reduction mode, and a screen movement mode of a screen displayed on the touch screen apparatus; a magnitude detecting step S35 for recognizing position information from the touch screen 210 and detecting the magnitude of an action force Fᵢₙ from the tactile sensor 230 when the action force Fᵢₙ is inputted; and a screen determining step S40 for determining and displaying an enlargement or reduction ratio of the screen, movement of the screen, or generation of a click event based on the recognized position information, the magnitude of the detected action force Fᵢₙ, and the mode that is set in the mode setting step S30.

Preferably, the full-browsing display method further comprises a reference force setting step S10 and a web site connection step S20. Hereinafter, a preferred embodiment is described with reference to drawings.

First, the step of setting a reference force in the touch screen apparatus S10 is described. In order to determine enlargement, reduction, or movement of a web site screen, it is preferable that a user previously sets a reference force Fₛ in an environment setting mode that is separately provided. The user applies an action force Fᵢₙ of certain magnitude in a reference force setting mode among the environment setting mode. At this point, a signal proportional to the strength of the action force is outputted from the tactile sensor 230 due to the applied action force Fᵢₙ, and the output signal is stored in the touch screen apparatus as a reference force Fₛ. Accordingly, since magnitude of an action force applied to the touch screen apparatus is different depending on a user, the reference force Fₛ may be set differently for each user. The step of setting a reference force is completed through the process. Hereinafter, in order to easily describe the enlargement, reduction, or movement of the screen, it will be described assuming that the reference force Fₛ is 1N.

Next, the connection step S20 for inputting a web site address in the touch screen apparatus and connecting to the web site is described. The user inputs the address (URL) of a desired web site in the touch screen apparatus, which is accomplished in a method of applying an action force Fᵢₙ using a pointing object on the keypad screen of the touch screen apparatus. The method of inputting a web site address in the touch screen apparatus (or, a method of inputting the address using “Favorites”) and connecting to the inputted web site is apparent within the scope of those skilled in the art, and thus detailed description thereof will be omitted. If the contents to be displayed on the touch screen apparatus are not a web page but a document file, the connection step S20 may be omitted and replaced with a step of opening a document file.

Next, a method for displaying a screen of a web site displayed on the touch screen apparatus in a desired form by the user S30 and S40 is described. Fundamentally, the screen determining step S40 is a method of comparing the magnitude of the reference force Fₛ previously set by the user with the magnitude of an action force S43, and determining an enlargement or reduction ratio of the screen, movement of the screen, or generation of a click based on the result of the comparison S44.

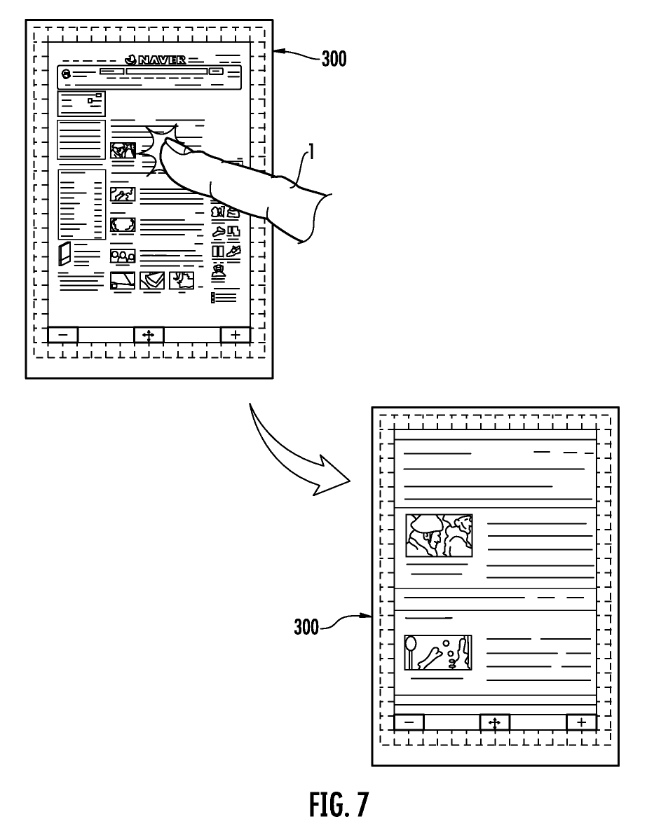

First, a full-browsing display method for determining enlargement of a screen is described with reference to FIG. 7. As shown in FIG. 7, the touch screen apparatus is set to the enlargement mode by selecting the enlargement button 303 among the screen control means S30. Thereafter, the user applies an action force Fᵢₙ at a point desired to be enlarged on a screen of a web site using the pointing object 1.

Then, the tactile sensor 230 outputs detection signals from an area around the point where the action force Fᵢₙ is applied. The largest output value among the detection signals generated by the tactile sensor 230 or an average value thereof can be assigned as the action force Fᵢₙ S35. Then, a position value (e.g., an x and y coordinate value) of the point where the action force Fᵢₙ is applied may be basically outputted from the touch screen apparatus or obtained through force distribution of the tactile sensor 230. Next, the point where the action force Fᵢₙ is applied moves to the center of the touch screen 210, and the screen is enlarged S40. At this point, if the action force Fᵢₙ applied by the user is 2N, the enlargement ratio will be two in proportional to the absolute value of the action force, and if the action force is 4N, the enlargement ratio will be four. That is, a parameter that determines the enlargement ratio of the screen is the magnitude of the action force Fᵢₙ.

As described above, the full-browsing display method for determining enlargement of a screen can be implemented such that if the user sets the enlargement mode by selecting the enlargement button 303 among the screen control means S30 and then clicks again a point desired to be enlarged on the screen of the web site with a force of 2N, the clicked point moves to the center of the display unit, and the screen is enlarged double S40. In addition, the full-browsing display method for determining enlargement of the screen also can be implemented such that while a user continuously applies a certain action force on the enlargement button 303 among the screen control means with the pointing object 1 (e.g., a thumb), if the user applies an action force of 2N at a point desired to be enlarged with another pointing object 1′ (e.g., an index finger), the point moves to the center of the touch screen, and the screen is enlarged double. An enlargement ratio of the screen may be determined in proportion to the absolute value of the action force Fᵢₙ applied by the user, or the action force Fᵢₙ is compared with (e.g., subtracted from or divided by) the reference force Fₛ, and the enlargement ratio can be determined to be proportional to the difference. Particularly, the enlargement ratio can be determined by comparing (e.g., subtracting or dividing) an action force Fᵢₙ applied when the enlargement button 303 among the screen control means is clicked with (from or by) the reference force Fₛ.

Next, a full-browsing display method for determining reduction of a screen is described. The user sets the touch screen apparatus to the reduction mode by selecting the reduction button 301 among the screen control means S30. Thereafter, the user applies an action force Fᵢₙ at a point desired to be reduced on a screen of a web site using the pointing object 1. At this point, since the position and the magnitude of the action force Fᵢₙ are determined in the same manner as that of screen enlargement, descriptions thereof will be omitted. The point where the action force Fᵢₙ is applied moves to the center of the touch screen, and the screen is reduced at a certain display ratio S40. At this point, if the action force Fᵢₙ applied by the user is 2N, the reduction ratio will be two in proportional to the absolute value of the action force, and if the action force Fᵢₙ is 4N, reduction ratio will be four.

In the same manner as the full-browsing display method for determining enlargement of a screen, the full-browsing display method for determining reduction of a screen can be implemented such that if the user sets the reduction mode by clicking the reduction button 301 among the screen control means S30 and then clicks again a point desired to be reduced with a force of 2N, the clicked point moves to the center of the touch screen, and the screen is reduced by half S40. In addition, the full-browsing display method for determining reduction of a screen also can be implemented such that while a user continuously applies a certain action force on the reduction button 301 among the screen control means with the pointing object 1 (e.g., a thumb), if the user applies an action force of 2N on a point desired to be reduced with another pointing object 1′ (e.g., an index finger), the point moves to the center of the touch screen, and the screen is reduced by half. A reduction ratio of the screen may be determined in proportion to the absolute value of the action force Fᵢₙ applied by the user, or the action force Fᵢₙ is compared with (e.g., subtracted from or divided by) the reference force Fₛ, and the reduction ratio can be determined to be proportional to the difference. Particularly, the reduction ratio can be determined by comparing (e.g., subtracting or dividing) an action force Fᵢₙ applied when the reduction button 301 among the screen control means is clicked with (from or by) the reference force Fₛ.

Hereinafter, a full-browsing display method for determining movement of a screen is described. Movement of a screen is a broad sense, which can be divided into a case where the screen is displayed moving up, down, left, and right along a trajectory of an applied action force (movement of a screen in a narrow sense: scroll) and a case where the screen is moved to a hyperlinked web site according to generation of a click event. In order to move the screen in a broad sense, a user first sets the touch screen apparatus to the screen movement mode by selecting the movement button 302 among the screen control means S30.

Hereinafter, the case where the screen is displayed moving up, down, left, and right along a trajectory of an applied action force (scroll) is described. In the case where the touch screen is set to the screen movement mode S30 and the user drags the pointing object 1 on the surface of the touch screen while applying an action force Fᵢₙ, if the magnitude of the action force Fᵢₙ is smaller than that of a reference force Fₛ, the screen moves in the direction of the drag S40. Or, the point pressed by the pointing object 1 may move to the center of the touch screen. Through these steps, the screen can be scrolled in a certain direction such as up, down, left, or right, or in a diagonal direction.

Hereinafter, the case where the screen is moved to a hyperlinked (HTML) web site according to generation of a click event is described. If a user applies an action force Fᵢₙ greater than the reference force Fₛ while the touch screen is set to the screen movement mode S30, the screen moves to another site that is hyperlinked to the point where the action force Fᵢₙ is applied, and an activated web page screen of the corresponding site is displayed to the user S40.

That is, if the action force Fᵢₙ is smaller than the reference force Fₛ, which is a concept of a narrow sense, screen movement (a scroll) is performed S41 (a scroll movement step). If the action force Fᵢₙ is greater than the reference force Fₛ, the screen moves to another web page specified by the hyperlink and switched to an activated screen S42 (a hyperlink movement step).

At this point S42, it is preferable to further perform a step of outputting a certain sound effect or vibration to a user in order to give the user a feeling of a click. As an example of the vibration, a reaction force Fₒᵤₜ reflecting the attributes of the action force Fᵢₙ applied by the user and proportional to the action force may be outputted. Accordingly, in this case, the touch screen apparatus using tactile sensors 230 preferably further comprises actuators 220 for implementing vibration and a control unit 440 for generating control signals for driving the actuators. These are driven as described above with reference to FIG. 4. Certain vibration for giving a feeling of a click may be implemented using a publicized vacuum motor, vibrator, or the like provided in a cellular phone.

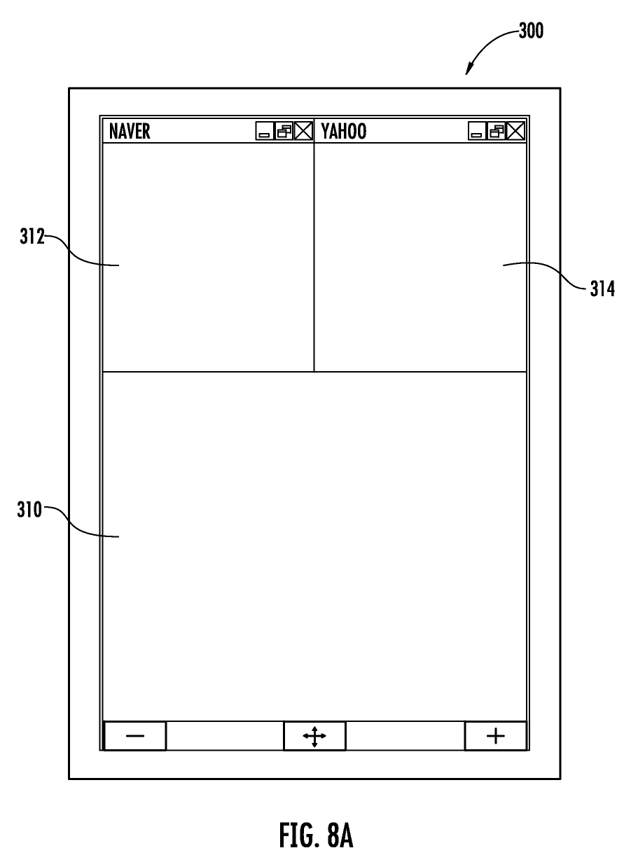

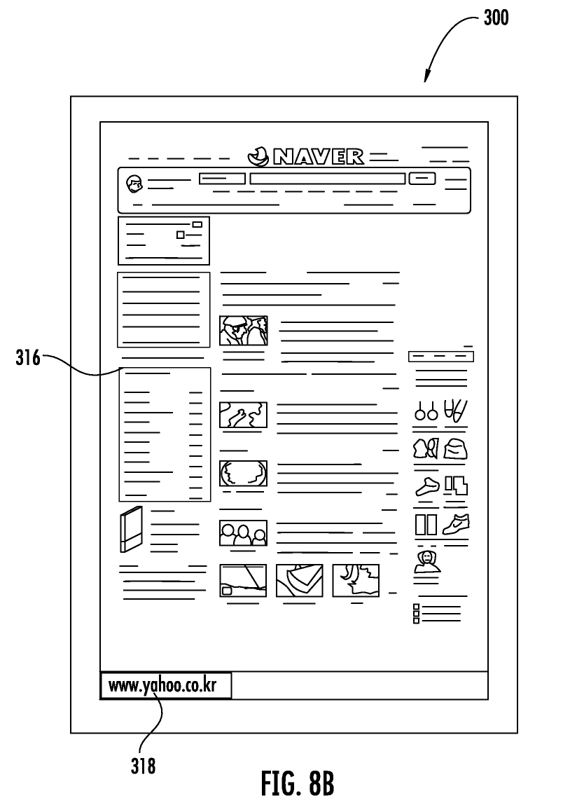

FIG. 8a is a view showing a plurality of active windows 312 and 314 of a web site floated on the background screen 310 of the touch screen, and FIG. 8b is a view showing an embodiment where an active screen 316 and an inactive window 318 are displayed on the screen. As shown in FIGS. 8a and 8b, it is preferable that the touch screen is implemented in an environment that is the same as that of a PC, since a user may handle the touch screen further easily.

<Recording Medium>

A recording medium for implementing the full-browsing display method as described above has a program recorded thereon for executing a reference force setting step of setting a reference force Fₛ by a user; a mode setting step of setting, based on an input of the user, any one of an enlargement mode, a reduction mode, and a screen movement mode of a screen displayed on the touch screen apparatus; a magnitude detecting step of recognizing position information from the touch screen 210 and detecting the magnitude of an action force Fᵢₙ from the tactile sensor 230 when the action force Fᵢₙ is inputted; and a screen determining step of determining and displaying an enlargement or reduction ratio of the screen, movement of the screen, or generation of a click event based on the recognized position information, the magnitude of the detected action force Fᵢₙ, and the set mode.

Then, such a recording medium is readable by a computing system included in the touch screen apparatus comprising a touch screen 210 that is a medium for receiving a position or operation command from a user using the pointing object 1, being applied with an action force Fᵢₙ of the pointing object 1, and recognizing the applied position information; and a plurality of tactile sensors 230 placed along the edge of the bottom surface of the touch screen 210, for detecting the action force Fᵢₙ and generating a certain signal.

### Modified Embodiment

As still another embodiment of the present invention, the reduction 301 and the enlargement 303 may be controlled using one screen control means. In other words, the touch screen apparatus may be configured to display the reduction 301 and the enlargement 303 as one zoom button (not shown), perform the reduction display step described above when an action force is smaller than the reference force Fₛ, and perform the enlargement display step described above when the action force is greater than the reference force Fₛ. At this point, a reduction display ratio and an enlargement display ratio may be determined depending on a difference between the action force and the reference force Fₛ.

As still another embodiment, the full-browsing display method of a touch screen apparatus using tactile sensors may be implemented in the touch screen apparatus, such as a cellular phone, a pocket device, a personal portable device (e.g., PDA or PMP) that can be used by a user with one hand, or the like.

As still another embodiment, although the full-browsing display method of a touch screen apparatus using tactile sensors is described as enlarging, reducing, or moving a web site screen, it is apparent that the method can be applied to a case where electronic books or documents are read, in addition to the web site screen.

As still another embodiment, the step of outputting a certain effect sound or vibration may be included in the enlargement mode or reduction mode to allow a user to guess the size of an enlarged or reduced screen by feeling the magnitude of a reaction force Fₒᵤₜ corresponding to an action force Fᵢₙ applied by himself or herself.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A full-browsing display method of a touch screen apparatus comprising a touch screen that is a medium for allowing a user to input a position or operation command thereto using a pointing object, being applied with an action force of the pointing object, and recognizing the applied position information; and a plurality of tactile sensors arranged along an edge of a bottom surface of the touch screen, for detecting the action force and generating a certain signal, the method comprising:
a mode setting step of setting, based on an input of the user, any one of an enlargement mode, a reduction mode, and a screen movement mode of a screen displayed on the touch screen apparatus;
a magnitude detecting step of recognizing position information from the touch screen and detecting the magnitude of an action force from the tactile sensor when the action force is inputted; and
a screen determining step of determining and displaying an enlargement or reduction ratio of the screen, movement of the screen, or generation of a click event based on the recognized position information, the magnitude of the detected action force, and the mode that is set in the mode setting step.

2. The method according to claim 1, wherein when the enlargement or reduction mode of the screen is selected in the mode setting step, the enlargement or reduction ratio of the screen in the screen determining step is determined in proportion to an absolute value of the action force.

3. The method according to claim 1, wherein the screen determining step further comprises the step of moving a screen of a point where the action force is applied to a center of the touch screen based on the position information.

4. The method according to claim 2, wherein the screen determining step further comprises the step of moving a screen of a point where the action force is applied to a center of the touch screen based on the position information.

5. The method according to claim 1, further comprising a reference force setting step of allowing the user to set the reference force Fₛ before performing the mode setting step.

6. The method according to claim 5, further comprising a connection step, between the reference force setting step and the mode setting step, of connecting to a web site by inputting an address of the web site in an Internet address window of the touch screen apparatus or specifying the web site through favorites.

7. The method according to claim 5, wherein the screen determining step comprises the steps of comparing the magnitude of the action force with the magnitude of the set reference force; and determining the enlargement or reduction ratio of the screen, movement of the screen, or generation of the click event based on a result of the comparison.

8. The method according to claim 7, wherein the comparison step compares the magnitude of the action force with the magnitude of the reference force by subtracting or dividing the magnitude of the action force from or by the magnitude of the reference force.

9. The method according to claim 5, wherein when the screen movement mode is selected in the mode setting step, the screen determining step comprises the steps of:
displaying the screen of the touch screen apparatus moving along a trajectory of the applied action force, when the magnitude of the action force is smaller than the magnitude of the reference force; and
displaying the screen moving to a hyperlinked specific web site according to generation of the click event at a point where the action force is applied, when the magnitude of the action force is greater than the magnitude of the reference force.

10. The method according to claim 9, wherein the step of moving to a hyperlinked web site and displaying a screen further comprises the step of outputting a certain effect sound or vibration when the screen moves to the hyperlinked web site.

11. The method according to claim 1, wherein the magnitude detecting step of detecting the magnitude of the action force detects a maximum value or an average value of output signals outputted by the plurality of tactile sensors as the magnitude of the action force.

12. A recording medium that is readable by a computing system included in a touch screen apparatus comprising a touch screen that is a medium for allowing a user to input a position or operation command thereto using a pointing object, being applied with an action force of the pointing objects and recognizing the applied position information; and a plurality of tactile sensors placed along an edge of a bottom surface of the touch screen, for detecting the action force and generating a certain signal, the recording medium having a program recorded thereon for executing:
a reference force setting step of allowing the user to set the reference force;
a mode setting step of setting, based on an input of the user, any one of an enlargement mode, a reduction mode, and a screen movement mode of a screen displayed on the touch screen apparatus;
a magnitude detecting step of recognizing position information from the touch screen and detecting the magnitude of the action force from the tactile sensor when the action force is inputted; and
a screen determining step of determining and displaying an enlargement or reduction ratio of the screen, movement of the screen, or generation of a click event based on the recognized position information, the magnitude of the detected action force, and the set mode.
